(19) United States
(12) Patent Application Publication
(10) Pub. No.: US 2007/0046179 A1
(43) Pub. Date: Mar. 1, 2007

(54) ORGANIC ELECTRO-LUMINESCENT DEVICE

(76) Inventors: Chan-Ching Chang, Taoyuan County (TW); Hsiao-Wen Huang, Tainan County (TW); Chin-Hsin Chen, Taipei City (TW); Ta-Ya Chu, Taipei City (TW); Chi-Hung Liao, Taichung City (TW); Shih-Kuei Lo, Taoyuan County (TW); Shuenn-Jiun Tang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,033

(22) Filed: Aug. 26, 2005

(51) Int. Cl. H01J 1/62; H01J 63/04

(52) U.S. Cl. 313/504

(57) ABSTRACT

An organic electro-luminescent device including a substrate, a plurality of organic electro-luminescent units and at least one tungsten oxide layer is provided. The organic electro-luminescent units are stacked on the substrate, and each tungsten oxide layer is disposed between the adjacent organic electro-luminescent units. The organic electro-luminescent device having the at least one tungsten oxide layer therein has good luminance efficiency. Moreover, another organic electro-luminescent device is also provided in the present invention.

### BACKGROUND OF THE INVENTION

1. Field of the Invention

The present invention generally relates to an emitting device. More particularly, the present invention relates to an organic electro-luminescent device.

2. Description of Related Art

Organic electro-luminescent devices emit light from organic functional materials thereof for displaying. Generally, the organic electro-luminescent devices are divided into small molecule organic electro-luminescent devices (SM-OELD) and polymer electro-luminescent devices (PELD) in accordance with the type of the organic functional materials. Both the SM-OLED and PLED are composed of a pair of electrodes and an organic functional layer.

FIG. 1 is a cross-section view showing a conventional organic electro-luminescent device. As shown in FIG. 1, the organic electro-luminescent device 100 includes a substrate 110, an anode layer 120, an organic functional layer 130 and a cathode layer 140. The anode layer 120 is formed on the substrate 110 and has a material of indium tin oxide. The organic functional layer 130 is formed on the anode layer 120 and is composed of several organic films. The cathode layer 140 is formed on the organic functional layer 130 and is constituted of a metal.

When a voltage is applied on the device 100, holes are injected into the organic functional layer 130 from the anode layer 120 while electrons are injected into the organic functional layer 130 from the cathode layer 140. The electrons and holes recombine in the organic functional layer 130 and generate excitons. When the excitons release energy and are back to the ground state, a portion of energy generated therefrom will transfer into photons so as to emit light.

However, the conventional organic electro-luminescent device 100 exists a problem of light emits from the organic functional layer 130 may reflect and refract inside the device 100 because the films of the device 100 have different refractive index so that partial light may be trapped inside the device and cannot emit out of the substrate 110. Therefore, the organic electro-luminescent device 100 does not have good luminance efficiency. In order to resolve the problem of poor luminance efficiency, a method of applying a higher driving voltage to the device 100 is utilized. But using higher driving voltage causes higher power consuming and device lifetime reduction.

### SUMMARY OF THE INVENTION

Accordingly, the present invention is directed to an organic electro-luminescent device having good luminance efficiency.

The present invention is directed to an organic electro-luminescent device having lower driving voltage.

According to an embodiment of the present invention, an organic electro-luminescent device is provided. The organic electro-luminescent device comprises a substrate, a plurality of organic electro-luminescent units and at least one tungsten oxide (WO₃) layer. The organic electro-luminescent units are stacked on the substrate. Each tungsten oxide layer is sandwiched between the adjacent organic electro-luminescent units.

According to an embodiment of the present invention, each tungsten oxide layer has a thickness in a range of 0.5˜30 nm.

According to an embodiment of the present invention, each organic electro-luminescent unit comprises an anode layer, a cathode layer and an organic functional layer between the anode layer and the cathode layer.

According to an embodiment of the present invention, the organic electro-luminescent unit adjacent to the substrate comprises an anode layer on the substrate and an organic functional layer over the anode layer, and the tungsten oxide layer disposed on the organic functional layer is used as a cathode layer of the organic electro-luminescent unit. In addition, the anode layer is a transparent conductive layer such as an indium tin oxide (ITO) layer, an indium zinc oxide (IZO) layer or an aluminum zinc oxide (AZO) layer.

According to an embodiment of the present invention, the organic electro-luminescent unit distant from the substrate comprises a cathode layer and an organic functional layer underneath the cathode layer, and the tungsten oxide layer underneath the organic functional layer is used as an anode layer of the organic electro-luminescent unit. In addition, the cathode layer has a material selected from the group consisting of aluminum (Al), calcium (Ca), magnesium (Mg), indium (In), stannum (Sn), manganese (Mn), silver (Ag), gold (Au), an alloy containing Mg and a combination thereof.

According to an embodiment of the present invention, the organic electro-luminescent unit adjacent to the substrate comprises an anode layer on the substrate and an organic functional layer over the anode layer, and the tungsten oxide layer disposed on the organic functional layer functions a cathode layer of the organic electro-luminescent unit adjacent to the substrate. The organic electro-luminescent unit distant from the substrate comprises a cathode layer and an organic functional layer underneath the cathode layer, and the tungsten oxide layer underneath the organic functional layer functions an anode layer of the organic electro-luminescent unit distant from the substrate.

According to an embodiment of the present invention, the substrate comprises a glass substrate, a plastic substrate or a flexible substrate.

According to another embodiment of the present invention, an organic electro-luminescent device is provided. The organic electro-luminescent device comprises a substrate, an anode layer over the substrate, a plurality of organic functional layers stacked over the anode layer, at least one tungsten oxide layer which is sandwiched between the adjacent organic functional layers and a cathode layer disposed over the organic functional layer distant from the substrate.

According to an embodiment of the present invention, each tungsten oxide layer has a thickness in a range of 0.5˜30 nm.

According to an embodiment of the present invention, the anode layer is a transparent conductive layer, such as an indium tin oxide (ITO) layer, an indium zinc oxide (IZO) layer or an aluminum zinc oxide (AZO) layer.

According to an embodiment of the present invention, the cathode layer has a material selected from the group consisting of aluminum (Al), calcium (Ca), magnesium (Mg), indium (In), stannum (Sn), manganese (Mn), silver (Ag), gold (Au), an alloy containing Mg and a combination thereof.

According to an embodiment of the present invention, the substrate comprises a glass substrate, a plastic substrate or a flexible substrate.

Accordingly, the tungsten oxide layer is used for connecting the adjacent organic electro-luminescent units or the adjacent organic functional layers and to be a charge generation layer. Comparing with the conventional devices, the organic electro-luminescent device of the present invention has better luminance efficiency.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-section view showing a conventional organic electro-luminescent device.

FIG. 2 is a cross-section view showing an organic electro-luminescent device according to a first embodiment of the present invention.

FIG. 3 is a cross-section view showing an organic electro-luminescent device according to a second embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

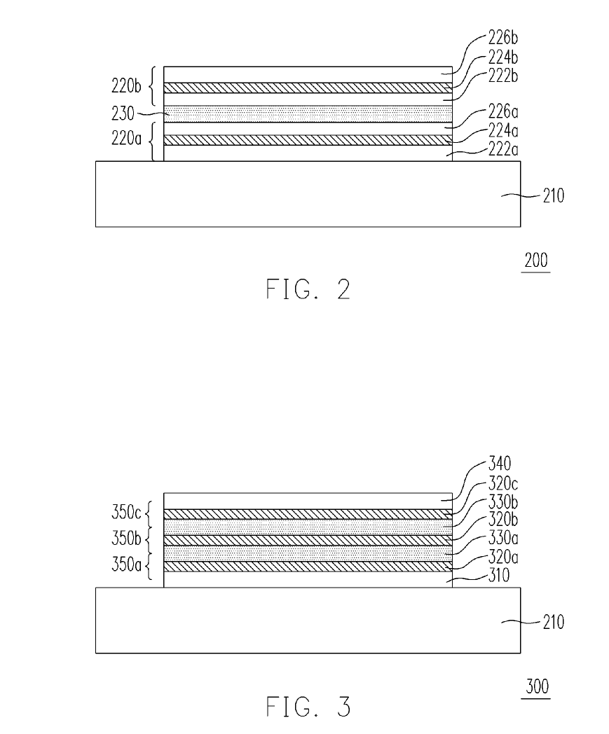

FIG. 2 is a cross-section view showing an organic electro-luminescent device according to a first embodiment of the present invention. As shown in FIG. 2, the organic electro-luminescent device 200 comprises a substrate 210, a plurality of organic electro-luminescent units 220a, 220b and at least one tungsten oxide layer 230. These organic electro-luminescent units 220a, 220b are stacked on the substrate 210. The tungsten oxide layer 230 is sandwiched between the two organic electro-luminescent units 220a, 220b. The substrate 210 can be a glass substrate, a plastic substrate or a flexible substrate, for example.

In details, the organic electro-luminescent unit 220a includes an anode layer 222a, a cathode layer 226a and an organic functional layer 224a between the anode layer 222a and the cathode layer 226a. The organic functional layer 224a mainly comprises an organic emitting layer. The organic functional layer 224a may further comprises a hole injection layer, a hole transporting layer, an electron transporting layer, an electron injection layer or a combination thereof, if necessary. In addition, the anode layer 222a can be a transparent conductive layer, for example. The transparent conductive layer has a material selected from the group consisted of indium tin oxide (ITO), indium zinc oxide (IZO), aluminum zinc oxide (AZO) and a combination thereof. The anode layer 222a can be formed by sputtering process, for example.

Similarly, the organic electro-luminescent unit 220b includes an anode layer 222b, a cathode layer 226b and an organic functional layer 224b between the anode layer 222b and the cathode layer 226b. The organic functional layer 224b is similar to the organic functional layer 224a and mainly comprises an organic emitting layer. The organic functional layer 224b may also further comprises a hole injection layer, a hole transporting layer, an electron transporting layer, an electron injection layer or a combination thereof, if necessary. In addition, the cathode layer 226b has a material selected from the group consisting of aluminum (Al), calcium (Ca), magnesium (Mg), indium (In), stannum (Sn), manganese (Mn), silver (Ag), gold (Au), an alloy containing Mg and a combination thereof. The alloy containing Mg is, for example, Mg—Ag alloy, Mg—In alloy, Mg—Sn alloy, Mg—Sb alloy or Mg—Te alloy.

As shown in FIG. 2, the tungsten oxide layer 230 has a thickness in a range of 0.5˜30 nm. The tungsten oxide layer 230 can be formed by evaporation process, for example. The tungsten oxide layer 230 is not only used as a connecting layer for the two organic electro-luminescent units 220a, 220b but also as a charge generation layer. In other words, each tungsten oxide layer can connect the adjacent organic electro-luminescent units and improve the electron/hole injection and transporting.

In details, when a voltage is applied on the organic electro-luminescent device 200, the charge generation layer (tungsten oxide layer) 230 provides electrons and holes into the organic electro-luminescent units 220a and 220b so that electrons and holes from the anode layer, the cathode layer and the charge generation layer may further recombine in the organic electro-luminescent units 220a and 220b to emit light so as to improve luminance efficiency.

TABLE 1

| | thick- | | power | | external | | |
|---|---|---|---|---|---|---|---|
| | ness | | ef- | volt- | quantum | | |
| | of WO₃ | yield | ficiency | age | efficiency | | |
| | (nm) | (cd/A) | (lm/W) | (V) | (%) | CIEx | CIEy |
| Example 1 | 0 | 13.4 | 1.3 | 32 | 3.4 | 0.25 | 0.69 |
| Example 2 | 1 | 49.2 | 5.5 | 28 | 12.6 | 0.27 | 0.68 |
| Example 3 | 2 | 45.6 | 6.8 | 21 | 11.6 | 0.28 | 0.67 |
| Example 4 | 4 | 34.9 | 5.5 | 20 | 8.8 | 0.33 | 0.64 |
| Example 5 | 12 | 30.9 | 5.0 | 19 | 7.8 | 0.34 | 0.63 |
| Example 6 | 21 | 25.6 | 4.1 | 20 | 6.7 | 0.35 | 0.62 |
| Example 7 | 30 | 21.1 | 3.4 | 20 | 5.6 | 0.37 | 0.61 |

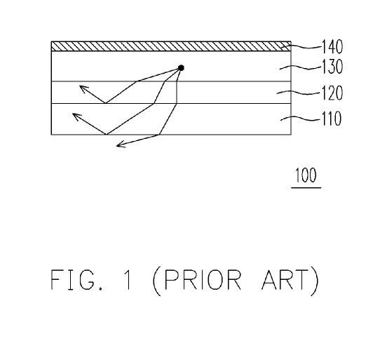

Example 1˜7 are organic electro-luminescent devices having tungsten oxide layers therein having different thickness, and the device performance thereof are measured and listed in Table 1. In Example 1˜7, the current density is 20 mA/cm², and each organic electro-luminescent unit has an area of 3×3 mm². In addition, the organic electro-luminescent device of Example 1 has only one organic electro-luminescent unit and has no tungsten oxide layer therein (the device is as shown in FIG. 1). The organic electro-luminescent devices of Example 2˜7 have two organic electro-luminescent units and one tungsten oxide layer therein (the device is as shown in FIG. 2). Example 1˜7 are green-light organic electro-luminescent devices. Yield (cd/A) also indicates luminance efficiency.

As shown in Table 1, the luminance efficiency is increased as the thickness of the tungsten oxide layer is reduced. The luminance efficiency of Example 2˜7 is better than that of Example 1, and the luminance efficiency of Example 2 is excellent. In details, the device of Example 2 has luminance efficiency of 49.2 cd/A and has external quantum efficiency of 12.6%, and the CIE coordinate thereof is (X=0.27, Y=0.68) that is near the CIE coordinate of pure green light (X=0.272, Y=0.672). Comparing with the Example 1, Example 2˜7 have better luminance efficiency and lower driving voltage.

It is noted that the number of organic electro-luminescent unit in the organic electro-luminescence device of the present invention is not limited. The organic electro-luminescence device can comprise two or more organic electro-luminescent units. In addition, the organic electro-luminescent units in the organic electro-luminescent device can be the same or different. Light emitted from the organic electro-luminescent units can be the same or different.

### Second Embodiment

FIG. 3 is a cross-section view showing an organic electro-luminescent device according to a second embodiment of the present invention. As shown in FIG. 3, the device in the second embodiment is similar to the device in the first embodiment, and the difference therebetween is that the organic electro-luminescent device 300 in the second embodiment has a plurality of organic functional layers 320a, 320b, 320b stacked on an anode layer 310. The tungsten oxide layer 330a is disposed between the adjacent organic functional layers 320a, 320b while the tungsten oxide layer 330b is disposed between the adjacent organic functional layers 320b, 320c. A cathode layer 340 is formed on the organic functional layer 320c that is distant from the substrate 210. The tungsten oxide layers 330a, 330b can be formed by evaporation process so that the organic functional layers 320a and 320b are not damaged when forming the tungsten oxide layers 330a, 330b.

In details, the tungsten oxide layer 330a, the organic functional layer 320a and the anode layer 310 forms an organic electro-luminescent unit 350a so that the tungsten oxide layer 330a also functions a cathode layer of the organic electro-luminescent unit 350a. Similarly, the tungsten oxide layer 330a, the organic functional layer 320b and the tungsten oxide layer 330b forms another organic electro-luminescent unit 350b so that the tungsten oxide layer 330a and the tungsten oxide layer 330b respectively function an anode layer and a cathode layer of the organic electro-luminescent unit 350b. Similarly, the tungsten oxide layer 330b, the organic functional layer 320c and the cathode layer 340 forms another organic electro-luminescent unit 350c so that the tungsten oxide layer 330b also functions an anode layer of the organic electro-luminescent unit 350c. Each tungsten oxide layer connects the organic functional layers of the adjacent organic electro-luminescent units.

It should be noted that the structure of the organic electro-luminescent unit 220a or 220b in the first embodiment may also be applied to the second embodiment. For example, a cathode layer may further be formed between the organic functional layer 320a and the tungsten oxide layer 330a (like the cathode layer 226a in FIG. 2). In another embodiment, an anode layer may further be formed between the organic functional layer 320c and the tungsten oxide layer 330b (like the anode layer 222b in FIG. 2). In another embodiment, an anode layer is further formed between the organic functional layer 320b and the tungsten oxide layer 330a (like the anode layer 222b in FIG. 2), and a cathode layer is further formed between the organic functional layer 320b and the tungsten oxide layer 330b (like the cathode layer 226a in FIG. 2).

In the first and second embodiments, the films formed after the anode layer 222a, 310 are formed with the same process, such as evaporation process, so that the manufacturing time can be reduced and these films formed after the anode layer 222a, 310 can be formed continuously. In addition, the organic electro-luminescent devices of the first and second embodiments are bottom emission organic electro-luminescent devices for illustration. The organic electro-luminescent device of the present invention may also be a top emission organic electro-luminescent device. For example, if the arrangement of the cathode layer and the anode layer are exchanged, the light can emit from the top portion of the device.

Accordingly, the organic electro-luminescent device of the present invention has at least one tungsten oxide layer therein to be a charge generation layer and a connecting layer to connect the adjacent organic electro-luminescent units or the adjacent organic functional layers or the organic electro-luminescent unit and the organic functional layer which are adjacent. Comparing with the conventional electro-luminescent device, the organic electro-luminescent device of the present invention has better luminance efficiency and lower driving voltage.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An organic electro-luminescent device, comprising:
a substrate;
a plurality of organic electro-luminescent units stacked on the substrate; and
at least one tungsten oxide layer, wherein each tungsten oxide layer is sandwiched between the adjacent organic electro-luminescent units.

2. The organic electro-luminescent device according to claim 1, wherein each tungsten oxide layer has a thickness in a range of 0.5˜30 nm.

3. The organic electro-luminescent device according to claim 1, wherein each organic electro-luminescent unit comprises:
an anode layer;
a cathode layer; and
an organic functional layer between the anode layer and the cathode layer.

4. The organic electro-luminescent device according to claim 1, wherein the organic electro-luminescent unit adjacent to the substrate comprises:
an anode layer on the substrate; and
an organic functional layer over the anode layer, wherein the tungsten oxide layer disposed on the organic functional layer functions a cathode layer of the organic electro-luminescent unit.

5. The organic electro-luminescent device according to claim 4, wherein the anode layer is a transparent conductive layer.

6. The organic electro-luminescent device according to claim 5, wherein the transparent conductive layer has a material selected from the group consisting of indium tin oxide (ITO), indium zinc oxide (IZO), aluminum zinc oxide (AZO) and a combination thereof.

7. The organic electro-luminescent device according to claim 1, wherein the organic electro-luminescent unit distant from the substrate comprises:
a cathode layer; and
an organic functional layer underneath the cathode layer, wherein the tungsten oxide layer underneath the organic functional layer functions an anode layer of the organic electro-luminescent unit.

8. The organic electro-luminescent device according to claim 7, wherein the cathode layer has a material selected from the group consisting of aluminum (Al), calcium (Ca), magnesium (Mg), indium (In), stannum (Sn), manganese (Mn), silver (Ag), gold (Au), an alloy containing Mg and a combination thereof.

9. The organic electro-luminescent device according to claim 1, wherein:
the organic electro-luminescent unit adjacent to the substrate comprises an anode layer on the substrate and an organic functional layer over the anode layer, and the tungsten oxide layer disposed on the organic functional layer functions a cathode layer of the organic electro-luminescent unit adjacent to the substrate; and
the organic electro-luminescent unit distant from the substrate comprises a cathode layer and an organic functional layer underneath the cathode layer, and the tungsten oxide layer underneath the organic functional layer functions an anode layer of the organic electro-luminescent unit distant from the substrate.

10. The organic electro-luminescent device according to claim 1, wherein the substrate comprises a glass substrate, a plastic substrate or a flexible substrate.

11. An organic electro-luminescent device, comprising:
a substrate;
an anode layer over the substrate;
a plurality of organic functional layers stacked over the anode layer; and
at least one tungsten oxide layer, wherein each tungsten oxide layer is sandwiched between the adjacent organic functional layers; and
a cathode layer disposed over the organic functional layer distant from the substrate.

12. The organic electro-luminescent device according to claim 11, wherein each tungsten oxide layer has a thickness in a range of 0.5˜30 nm.

13. The organic electro-luminescent device according to claim 11, wherein the anode layer is a transparent conductive layer.

14. The organic electro-luminescent device according to claim 13, wherein the transparent conductive layer has a material selected from the group consisting of indium tin oxide (ITO), indium zinc oxide (IZO), aluminum zinc oxide (AZO) and a combination thereof.

15. The organic electro-luminescent device according to claim 11, wherein the cathode layer has a material selected from the group consisting of aluminum (Al), calcium (Ca), magnesium (Mg), indium (In), stannum (Sn), manganese (Mn), silver (Ag), gold (Au), an alloy containing Mg and a combination thereof.

16. The organic electro-luminescent device according to claim 11, wherein the substrate comprises a glass substrate, a plastic substrate or a flexible substrate.
